(19) United States
(12) Patent Application Publication
(10) Pub. No.: US 2024/0389629 A1
(43) Pub. Date: Nov. 28, 2024

(54) A PRODUCTION METHOD FOR DRIED APRICOTS

(71) Applicant: K.F.C. GIDA TEKSTIL SANAYI ITHALAT IHRACAT YATIRIM ANONIM SIRKETI, Menemen, Izmir (TR)

(72) Inventors: Damla Öykü SAHIN, Menemen, Izmir (TR); Ali NALBANT, Menemen, Izmir (TR); Cevat KOÇ, Menemen, Izmir (TR)

(21) Appl. No.: 18/693,774

(22) PCT Filed: Nov. 23, 2022
(86) PCT No.: PCT/TR2022/051344

§ 371 Date: Mar. 20, 2024

(30) Foreign Application Priority Data
Nov. 23, 2021 (TR) 2021/018301

(51) Int. Cl. A23L 33/135; A23L 19/00

(52) U.S. Cl. CPC A23L 33/135; A23L 19/05

(57) ABSTRACT

Disclosed is a production method for dried apricots. In the production method, dried apricots containing sulfur dioxide are provided, followed by the obtaining of a probiotic oil solution from homogeneously mixing the powder mixture containing probiotics with liquid oil. The probiotic oil solution is then applied to the dried apricots, and the dried apricots treated with the probiotic solution are packaged.

### FIELD OF THE INVENTION

The invention relates to a production method to provide probiotic content in dried apricots which has extended shelf life with using sulfur dioxide and a dried apricot obtained by the related method.

### PRIOR ART

Dried foodstuffs, especially dried fruits, are highly preferred products in the market with their relatively long shelf life and the taste they provide.

Dried apricots are commonly produced and consumed in a sulfur dioxide-dried state for the preservation of the desired vibrant yellow color after drying and low microbial load, or in a way that meets the expression “ready to eat” used in the industry. In these products, after the moisture value of the product is increased to over 30% by hot rehydration at about 80° C., protection is provided with food preservatives such as potassium sorbate or by heat treatment such as pasteurization after packaging to provide more softness.

Coating or penetration of probiotic microorganisms into food products is a familiar practice in the food industry. Generally, in these and similar applications, those with proven probiotic mechanism of action from lactic acid bacteria are preferred. Probiotics cannot be stabilized in products containing sulfur dioxide, since the resistance of these bacteria which are added to the food later that is lower than that of lactic acid bacteria naturally found in food. In particular, logarithmic decreases are observed in the number of probiotic microorganisms applied to gain probiotic effect on sulphurous apricots, with the effect of sulfur dioxide depending on time. Due to the logarithmic decreases, the expected probiotic effect is not realized in the consumption of the final product. As a solution to this, more than one coating and high-dose sulfur dioxide application required in the use of spore microorganism with weaker stability as probiotics are carried out, which is a negative situation in terms of health, process cost and production time.

The following documents were encountered during the preliminary patent search.

In the document with the publication number CN112772762A, the method steps related to the use of Lactobacillus microorganism in order to have a probiotic effect on the coating applied to the dried fruits are explained.

In the document with the publication number 20,210,120832A1, mentioned the method steps in order to have a probiotic effect on dried apple slices for the application of the coating which the Bacillus Subtilis microorganism is used. In this study, Bacillus subtilis fermentation water is sprayed on both sides of the apple slice at 60° C.-80° C. using atomization spray technology. Then, the apple carbonyl ammonia reaction is initiated by irradiation to provide the burnt black appearance of the apple slices.

In the document with publication number WO2015186998A1, the method steps that ensure the survival of bacteria for a longer period than when used alone are explained by applying a coating containing probiotic bacteria to dried fruits and using more than one bacterial species. In this application, dried fruits are contacted with the probiotic organism composition for at least 1 hour, preferably at least 4 hours at approximately 37° C. and low pressure. Mentioned shelf life of this product about 4 months, which is insufficient to meet market needs.

As a result, all abovementioned problems have made it necessary to make an improvement in the relevant technical field.

### AIM OF THE INVENTION

The present invention aims to eliminate the abovementioned problems and to make a development in the relevant technical field.

The main object of the invention is to reveal a production method to provide a more stable and beneficial probiotic content in dried apricots with extended shelf life by using sulfur dioxide.

Another object of the invention is to eliminate the need for high-dose probiotic use and/or a dense coating to preserve the probiotic content.

### BRIEF DESCRIPTION OF THE INVENTION

The invention is related to a production dried apricot so as to fulfil all aims mentioned above and will be obtained from the following detailed description. According to this, the method comprises following steps; providing dried apricots containing sulfur dioxide; obtaining a probiotic oil solution by mixing homogeneously the powder mixture containing probiotics with liquid oil; applying said probiotic oil solution on dried apricots; and packaging of dried apricots treated with probiotic oil solution.

Thus, the stability of the probiotic microorganism has been increased with the co-encapsulation principle together with the high oleic acid oil solution, and accordingly the need for extra precautions for the protection of the microorganism has been eliminated.

In a preferred embodiment of the invention, mentioned powder probiotic contains at least one of maltodextrin, ascorbic acid, dextrin or inulin in its structure.

In a preferred embodiment of the invention, Bacillus subtilis that is in spore form is obtained by freeze-drying or spray-drying.

In a preferred embodiment of the invention, said dried apricot contains sulfur dioxide between 2000-3000 ppm according to the total weight.

In another preferred embodiment of the invention, the said probiotic oil solution is continuously stirred/mixed during the preparation and dripping process.

Thus, phase separation of the probiotic oil solution is prevented.

In a preferred embodiment of the invention, no coating is applied other than the probiotic oil solution.

Thus, the process cost was reduced and the process speed increased without sacrificing product quality.

The protection scope of the invention is specified in the claims and cannot be limited to the description made for illustrative purposes in this brief and detailed description. It is clear that a person skilled in the art can present similar embodiments in the light of the above descriptions without departing from the main theme of the invention.

### BRIEF DESCRIPTION OF DRAWINGS

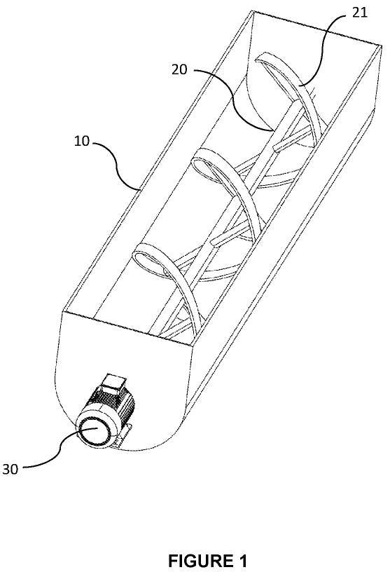

An isometric view of a drum that can be used in the method is given in FIG. 1.

The figures are not required to be scaled and the details which are not necessary for understanding the present invention may be neglected. Moreover, the elements that are at least substantially identical or have at least substantially identical functions been shown by the same number.

### DESCRIPTION OF THE REFERENCES IN FIGS

10. Body
20. Shaft
21. Mixing arm
30. Motor

### DETAILED DESCRIPTION OF THE INVENTION

In this detailed description, the invention a production method for dried apricot is described by means of examples only for clarifying the subject matter such that no limiting effect is created.

The subject of the invention relates to a production method to provide probiotic content in dried apricots which has extended shelf life with using sulfur dioxide and a dried apricot obtained by the related method.

The invention, a production method for dried apricot that has following steps; providing dried apricots containing sulfur dioxide; obtaining a probiotic oil solution by mixing homogeneously the powder mixture containing probiotics with liquid oil; applying said probiotic oil solution on dried apricots; and packaging of dried apricots treated with probiotic oil solution.

For the method subject to the invention, dried apricots that have been exposed to sulfur dioxide application are provided first. In following steps; the sulfur dioxide application is preferably carried out before the apricot is dried. Preferably, elemental sulfur is burned and the apricots are exposed to the fumes after the apricot crates are placed on ton of each other. After the mentioned process, the sulfur content in the apricot was maximum 3000 ppm. A sulfur content of more than 2000 ppm is called “high dose”.

After the sulfur application, the apricots keep on hold preferably under the sun or in hot air to be dried.

Dried apricots are made ready for coating by pre-processing by washing, removing foreign matter, sorting, etc.

Probiotic oil solution is used to be used as a coating. The expression probiotic oil solution refers to a solution containing at least Bacillus subtilis and high oleic acid sunflower oil or another oil of similar composition. Other vegetable oils can also be used like cotton etc., but any vegetable oil with a high oleic acid content is preferred to provide a stabilizing coencapsulation effect in terms of probiotic culture and to prevent rancid odor/taste with the vegetable oil with the highest oxidative stability throughout the product shelf life. When normal sunflower oil is used, its oxidative stability is weaker due to its high linoleic acid content, bad taste and odor occur in apricots, which means that a product with a long shelf life and stable in terms of organoleptic and probiotic properties cannot be obtained.

Said oil is preferably sunflower oil, but the processed variety with increased content defined as oleic acid, a monounsaturated omega-9 fatty acid, can also be used.

Bacillus subtilis was chosen as the probiotic microorganism. In the preferred embodiment, the B. subtilis Rosell®-179 strain is used. In addition, it may also contain maltodextrin and ascorbic acid with the probiotic microorganisms. The mentioned probiotic microorganism or maltodextrin, ascorbic, probiotic microorganism mixture can be supplied as freeze-dried or spray-dried before the preparation of the probiotic oil solution.

The aforementioned probiotic powder mixture can be found primarily suspended with processing aids such as maltodextrin and prebiotics such as inulin.

It is known that the sulfur environment creates an aggressive environment for microorganisms. Accordingly, a kind of coencapsulation method is followed by mixing the probiotic microorganism, maltodextrin, ascorbic acid mixture with vegetable oil with high oleic acid. While combining the inputs for the said mixture, the mixture is continuously mixed and possible phase separations are avoided.

The obtained probiotic oil solution contains high oleic acid liquid oil and based on the weight of the total solution, at least 3%, preferably (arranged according to the values given in the claims) between 3-20.6% powder probiotic mixture containing Bacillus subtilis and maximum 97%, preferably 79.4-97%, based on the weight of the total solution.

The probiotic oil solution obtained is mixed directly into the dried apricot mass and applied. In this step, preferably dried apricots are placed in a tank containing a screw mixer, mixed continuously and taken from the probiotic-oil solution that is mixed regularly in a separate place from the tank, and poured on the apricots especially dripped between 0.5-0.65% rates of apricots. To ensure a homogeneous mixture, 100 kg of product should be mixed for a minimum of 10 minutes.

Referring to FIG. 1; said drum comprises a longitudinally arranged body (10) and a shaft (20) longitudinally connected to said body (10). Mixing arms (21) are arranged to wrap the shaft (20) over the said shaft (20). Said mixing arms (21) are preferably provided helically. Said shaft (20) is associated with a motor (30), and it rotates with the drive provided by the said motor (30) and mixes the dried apricots within the body (10).

In the method of the invention, there is no need to apply more than one or different types of coating.

After the probiotic oil solution application process, the dried apricots are taken into crates and then packaged. Here, after the packaging process, the product can be stored for 12 to 18 months at ambient temperature.

The protection scope of the invention has been mentioned in the claims that are attached and the invention cannot be limited to the embodiments described in this detailed description. It is clear that a person skilled in the art can provide similar embodiments within the scope of the above-mentioned descriptions without deviating from the main theme of the invention.

1. A production method for dried apricot, comprising the following steps;
providing dried apricots containing sulfur dioxide;
obtaining a probiotic oil solution by mixing homogeneously a powder mixture containing probiotics with a liquid oil;
applying said probiotic oil solution on dried apricots; and
packaging of the dried apricots treated with said probiotic oil solution.

2. A production method according to claim 1, wherein the probiotic oil solution contains Bacillus subtilis between 3-20.6% by weight of the total solution, and high oleic acid oil between 79.4-97% by the weight of the total solution.

3. A production method according to claim 1, wherein application of said probiotic oil solution on the dried apricots is by dripping.

4. A production method according to claim 1, wherein the dried apricots with said probiotic oil solution are mixed with a drum.

5. A production method according to claim 1, wherein application of the probiotic oil solution is performed while mixing the dried apricots with a drum.

6. A production method according to claim 1, further comprising stirring of the probiotic oil solution continuously, during the preparation and coating of the dried apricots.

7. A production method according to claim 1, wherein the probiotic is in powder form.

8. A production method according to claim 7, wherein said probiotic is powdered by freeze-dry or spray-dry methods.

9. A production method according to claim 1, wherein the dried apricot contains sulfur dioxide between 2000-3000 ppm.

10. A production method according to claim 1, further comprising applying at least 3 g of the probiotic oil solution for each 1 kg of the dried apricots.

11. A production method according to claim 1, wherein the liquid oil is a high oleic acid oil.

12. A production method according to claim 11, wherein the high oleic acid oil is made from sunflower.

13. A production method according to claim 1, wherein the powder probiotic contains at least one of maltodextrin, ascorbic acid, dextrin or inulin in its structure.

14. A production method according to claim 1, wherein said probiotic is Bacillus subtilis.

15. A production method according to claim 1, wherein said probiotic is a minimum of 25×109 cfu/g.

16. A production method according to claim 1, wherein said probiotic is in sports form.

17. A production method according to claim 1, wherein no coating is applied other than the probiotic oil solution.

18. A dried apricot obtained by the production method according to claim 1.
